(19) United States
(12) Patent Application Publication
(10) Pub. No.: US 2010/0322783 A1
(43) Pub. Date: Dec. 23, 2010

(54) Rotor or stator blade and method for forming such rotor or stator blade

(75) Inventor: Inge Tronstad, Asker (NO)

Correspondence Address: CHRISTIAN D. ABEL, ONSAGERS AS, POSTBOKS 6963 ST. OLAVS PLASS, OSLO, N-0130, NO

(73) Assignee: NEBB TECHNOLOGY AS, Asker (NO)

(21) Appl. No.: 12/817,235

(22) Filed: Jun. 17, 2010

(30) Foreign Application Priority Data
Jun. 17, 2009 (GB) 0910497.7

(51) Int. Cl. F01D 5/18; B23P 15/02

(52) U.S. Cl. 416/97 R; 29/889.721

(57) ABSTRACT

A rotor blade or a stator blade for rotary machinery is disclosed where the rotor/stator blade comprises a number of thin blade plates. A plurality of the rotor/stator blades are provided with at least one hole forming at least one supply duct when the blade plates are stacked on top of each other to form the rotor/stator blade. The blade plates are joined together by means of sintering such that a solid rotor/stator blade with an outer surface is formed. The rotor/stator blade further comprises a system of distributing micro ducts extending from the at least one supply duct to the outer surface of the blade, fanning out in such a way that the number of micro ducts extending out to the outer surface of the rotor/stator blade is equal to or greater than the number of micro ducts extending from the at least one supply duct, thereby providing cooling liquid to the outer surface of the rotor/stator blade such that the cooling liquid cools the rotor/stator blade by evaporation when the rotor/stator blade is in use. There is also provided a method for manufacturing of such a rotor/stator blade.

The present invention relates to a rotor blade or a stator blade for rotary machinery and a method for manufacturing such a rotor/stator blade.

The thermal efficiency of a gas turbine is highly depending of the temperature level for energy supply to the process medium. The development of a more efficient gas turbine will generally create the need for higher temperatures in the inlet section and the first stages of the turbine expander. The high temperatures will enhance the requirements for more efficient systems for rotor/stator blade material protection against high temperature corrosion and for maintaining the material strength.

The practical limit for existing turbine blade materials without cooling is about 800° C. For higher temperatures various methods of blade protection have been developed and are in use. Examples include:
Protective covering (ceramic layers),
Internal blade cooling with separate cooling media, open systems with steam or gas cooling, and liquid film cooling.

Steam cooling in an open system may allow a turbine inlet temperature (TIT) up to approximately 1250° C. while liquid film cooling may allow TIT-temperatures up to 1350° C. A higher TIT may contribute to a significant increase in the thermal efficiency for a gas turbine power plant. An increase from for example 1250° C. to 1350° C. could increase the thermal efficiency by 2-3%.

In U.S. Pat. No. 4,221,539 A and U.S. Pat. No. 4,347,037 (both by Corrigan) there is disclosed a stator blade or a turbine blade which is made up of a stack of plates. In the surface of the plates there is provided grooves formed by photo etching. Furthermore, the plates are formed with a large hole and a plurality of struts extending from the pressure side to the suction side of the blade. The struts are thinner than the plate to ensure flow across the struts. The large holes necessitate the inclusion of the support struts to avoid the blade from collapsing. Because of the shape of the hole in the plates and the struts that each plate must be provided with, the plates of the blade disclosed in these two publications are time consuming and costly to manufacture.

Furthermore, the grooves formed in the plates of the blade disclosed in Corrigan are formed such that two legs from the internal supply duct are joined into a single exhaust port which is relatively long, extending from an upstream exhaust port section to the next adjacent exhaust port section. This configuration of the grooves allows a large enough amount of cooling liquid to be provided to form an insulating layer between the stator blade and the stream of hot gases thereby preventing unwanted heating of the stator blade. The exhaust ports are therefore also arranged at an angle such that the cooling liquid will flow along the surface in the same direction as the hot gases.

The objective of the present invention is to provide a rotor or stator blade which can withstand higher temperatures than known rotor/stator blades.

This objective is achieved by a rotor or stator blade according to claim 1, a method for the manufacturing a rotor or a stator blade according to claim 10 and a use of a sintering process for the manufacturing of such a rotor blade or a stator blade according to claim 17. Further embodiments of the rotor/stator blade and the method are defined in the dependent claims 2-9 and 11-16 respectively.

The idea behind the cooling of the rotor/stator blades of the present invention is to provide cooling for a rotor/stator blade that work in a way similar to the way the human body is protected against overheating with moisture (sweat) trickling out from the surface of the skin from a manifolded duct system for the sweat. A very efficient cooling is obtained when sweat is evaporating and with a continuous moistening of the surface through the skin from the backing liquid distribution channel system.

By providing the rotor/stator blades with one or more internal supply ducts and a manifolded system of micro ducts extending from the internal supply duct or ducts to the surface of the rotor/stator blades there is obtained a system for cooling the rotor/stator blades where a continuous provision of a trickle of cooling fluid to the surface of the rotor/stator blades is evaporated by the hot gas flowing past the rotor/stator blades and thereby achieving the desired cooling effect of the rotor/stator blades in a similar way to the cooling of the human body by sweating.

When manufacturing a rotor/stator blade according to the present invention, thin blade plates are photo etched on one side with small micro grooves forming a manifold type of conduits from a hole in the centre of the blade plate to the outer edge of the blade plate. The etching pattern will typically be single conduits from a hole which is manifolded one or several times towards the outer edge which will be a part of the surface of the rotor/stator blade. Generally, a single plate element will correspond to a cross sectional area of the turbine blade.

Photo etching, also called photo chemical etching or milling, is a process where a desired image is etched on the surface of a metal part via a photosensitive template. The metal is then exposed to an appropriate acid that removes a layer of metal in areas left unprotected by the template. A wide variety of metals can be etched this way. Photo etching allows rapid design changes, exact repeatability, precise tolerances and burr-free edges, and it is a simple method for making intricate patterns. Photo etching uses photographic tooling plotted from CAD-files, eliminating expensive hard tooling. Parts can be made from metal plates as thin as 0.01 mm. This method is therefore excellent for milling of the micro duct system for establishing of a transport system for the cooling liquid for cooling of the turbine expander blades.

As already mentioned, each blade plate is thin, the thickness being less than 1 mm, and preferably about 0.5 mm or less, whereby a sufficient number of ducts leading to the surface of the finished blade may be provided. In that way, evaporation of cooling liquid may take place over the whole surface, ensuring that the temperature of the entire surface of the rotor/stator blade is kept at or below the maximum temperature that the rotor/stator blade can withstand. A rotor/stator blade of for example a height of 40 mm will therefore comprise of approximately 80 or more blade plates.

Generally, the depth of the micro grooves is in the order of half the thickness of a blade plate or less. The micro grooves in the blade plates, which become micro ducts in a finished blade, therefore typically have a depth, up to about 0.5 mm for a 1 mm thick blade plate, or up to about 0.25 mm in a 0.5 mm thick blade plate.

The grooved area, i.e. micro ducts within a finished rotor/stator blade, will be relatively large at or near the surface, while the inner sections will have few micro ducts, thus resulting in a satisfactory blade tensile strength. The pores on the surface of the rotor/stator blade may create some flexibility within the surface layers, which may contribute to reduced blade peak stress loads due to thermal gradients.

The method for creation of the grooves in the blade plates, i.e. the micro ducts in the rotor/stator blade, will facilitate the adaptation of the cooling intensity to the local blade surface heat load which will be highest along the front edge of the blade profile. The boundary layer flow pattern is created by the drag from the process gas flow and the centrifugal forces acting on the trickling and evaporating droplets. These forces will tend to form a thin liquid film of evaporating liquid (water is assumed) from the pores in a downstream direction. The large number of pores will create a large area with evaporating film which will intensify the evaporation process and consequently increase the cooling effect of the rotor/stator blade.

The amount of sweat, i.e. cooling liquid which is preferably water, will be flow controlled from the amount of cooling energy that is necessary to keep the surface temperature of the rotor/stator blade below a certain limit. The extremely large heat of evaporation for the cooling water will result in a very efficient surface cooling and efficient protection of the blade material against thermal degrading and loss of strength.

Furthermore, the evaporating cooling liquid, preferably water, will produce vapor, i.e. steam if the cooling liquid is water, which will mix with the process flow. The steam will contribute to the production of power through expansion from the injection pressure to the turbine exhaust pressure. The downstream processing will preferably be provided with a system for recovery of the evaporation/condensation heat energy. The open water evaporation cooling system will anyhow contribute to a minor reduction in the Carnot efficiency for the turbine cycle. The amount of cooling water should therefore be kept to a minimum. The extremely efficient “sweat cooling” will contribute to minimizing these cooling losses. The gain in thermal efficiency through this sweat cooling system is, in any case, much larger than the losses due to the reduced efficiency from the cooling water and steam fraction in the working medium.

Sintering is a method for making objects from powder, plates or other solids by heating the material up to a temperature below the melting point, i.e. solid state sintering, until its particles or surfaces adhere to each other through diffusion and/or other mechanisms. The ISO-definition of sintering is: “The thermal treatment of a powder or compact at a temperature below the melting point of the main constituent, for the purpose of increasing its strength by bonding together of the particles.” Sintering has traditionally been used for manufacturing of ceramic objects, but has also found uses in other fields such as metallurgy. The sintering process can be applied at atmospheric pressure or at elevated pressures. In both cases thermal energy is normally needed to reach sufficient temperatures. When sintering plates, high pressure will normally be applied. The sintering process itself can take place in for example a pressure sintering furnace.

There is provided a rotor/stator blade for rotary machinery where the rotor/stator blade comprises a number of thin blade plates. A plurality of the rotor/stator blades are provided with at least one hole forming at least one supply duct when the blade plates are stacked on top of each other to form the rotor/stator blade. The blade plates are joined together by means of sintering such that a solid rotor/stator blade with an outer surface is formed. The rotor/stator blade further comprises a system of distributing micro ducts extending from the at least one supply duct to the outer surface of the blade, fanning out in such a way that the number of micro ducts extending out to the outer surface of the rotor/stator blade is equal to or greater than the number of micro ducts extending from the at least one supply duct, thereby providing cooling liquid to the outer surface of the rotor/stator blade such that the cooling liquid cools the rotor/stator blade by evaporation when the rotor/stator blade is in use.

In an embodiment of the invention, the system of distributing micro ducts is formed by a plurality of single micro ducts extending from the at least one supply duct to the outer surface of the rotor/stator blade.

In a further embodiment of the invention, the system of micro ducts is formed by a one-to-many manifold type of micro ducts wherein at least one primary micro duct extends from the at least one supply duct to a first distributing node and two or more secondary micro ducts extend from the first distributing node to the outer surface of the rotor/stator blade. Normally a single primary micro duct connects the supply duct and the first distributing node, while two or more secondary ducts extend further to the outer surface of the rotor/stator blade. The distributing nodes may be defined as just the branching out of two or more secondary micro ducts from a primary duct, or alternatively the nodes may be formed by a cavity defining a volume at the end of the primary ducts, the secondary micro ducts extending from these nodes/cavities. The depth of the cavities are preferably no larger than the depth of the primary micro ducts.

In a further embodiment of the invention, at least one of the secondary micro ducts extends to a second distributing node from which two or more tertiary micro ducts extend to the outer surface of the rotor/stator blade, while the other secondary micro ducts, if there is any, extend directly to the outer surface of the rotor/stator blade. As above, normally there will be one secondary duct connecting a first distributing node and a secondary distributing node while two or more tertiary micro ducts extends to the outer surface of the rotor/stator blade and/or to yet a further distributing node. In principle, there is no limit for the number of nodes that the cooling liquid passes through before reaching the outer surface of the rotor/stator, but usually one, two or three distributing nodes will be sufficient to provide the necessary number of micro ducts to the outer surface of the rotor/stator blade.

In a further embodiment of the invention, the rotor/stator blade is provided with two or more supply ducts for cooling liquid, wherein each supply duct is provided with a separate system of micro ducts extending from the supply duct and spreading out towards the outer surface of the rotor/stator blade. The system of micro ducts is formed in the same way as explained above. Preferably one primary micro duct connects one of the supply ducts and a first distributing node while two or more secondary micro ducts each extend to the outer surface of the rotor/stator blade, or to one or more second distributing nodes from which tertiary micro ducts extend, either to the outer surface of the rotor/stator or a third distributing node, and so on.

In a further embodiment of the invention, the rotor/stator blade is provided with a bottom element and optionally a top plate, at least one of which comprises means for supplying cooling liquid to the at least one supply duct of the rotor/stator blade. The top plate, if provided, may form part of a sealing between the rotary and stationary parts of the rotary machine. Normally, the rotor/stator blade is attached to the rotor/stator by means of the bottom element. The supply of cooling liquid to the at least one supply duct in the rotor/stator blade will preferably take place through one or more suitable ducts passing through the bottom element and being arranged in fluid connection with the at least one supply duct in the rotor/stator blades.

In a further embodiment of the invention, all or at least a plurality of the blade plates, having an upper side, an underside and an outer edge, are provided with at least one hole and a system of distributing micro grooves in the surface of the upper side or underside of the blade plates, the micro grooves extending from the at least one hole to the edge of the blade plates. The more blade plates being provided with micro grooves, the more micro ducts will be formed in the rotor/stator blade and the larger will the cooling capacity of the outer surface of the rotor/stator blade be.

In a further embodiment of the invention, the thickness of the rotor/stator blade plates is less than 1 mm. In a preferred embodiment, the thickness of the blade plates is less than or equal to 0.5 mm. The micro grooves which are formed in the blade plates, are preferably provided with a depth which is less than or equal to half the thickness of the blade plates, i.e. 0.5 mm or less and preferably 0.25 mm or less.

There is also provided a method for the manufacturing of a rotor or a stator blade for rotary machinery wherein the following steps are carried out:
providing a number of thin blade plates with an upper side, an underside and an outer edge,
providing all or at least a plurality of the blade plates with at least one hole such that when the blade plates are stacked on top of each other into an assembly of blade plates, at least one supply duct for cooling liquid is formed by the holes.
   The method further comprises the steps of:
providing all or at least a plurality of the blade plates with a system of micro grooves in the surface of the upper side or the underside of the blade plates, the system of micro grooves fanning out from the at least one hole to the outer edge of the blade plates in such a way that the number of micro grooves extending to the outer edge of the blade plates is equal to or greater than the number of micro grooves extending from the at least one hole,
sintering the assembly of blade plates to form a solid rotor/stator blade with an outer surface, the sintered rotor/stator blade comprising the at least one supply duct and a system of micro ducts distributing the cooling liquid to the outer surface of the rotor/stator blade such that the cooling liquid cools the rotor/stator blade by evaporation when the rotor/stator blade is in use.

The rotor/stator blade is created from sintering of a relatively large number of thin grooved photo etched blade plates. The photo etching process will create a system of micro grooves and nodes in the surface of the upper or underside of the blade plates. The sintering process is accomplished by heating the stack of blade plates to a temperature of about 1200° C. under high pressure, resulting in strong bonding between the individual plates. The surface of the finished rotor/stator blade will have a large number of micro pores at the surface and a corresponding system of micro ducts and distributing nodes for distribution of cooling liquid from the at least one supply duct, through the micro ducts and subsequently to the outer surface of the rotor/stator blade.

The blade plates may be given the shape of a cross section of the rotor/stator blade according to the position of each individual blade plate in the stack of blade plates since the cross section of the rotor/stator blade in the longitudinal direction of the blade (the direction from the root of the blade to the tip of the blade) may not be uniform.

In a further embodiment of the invention, the method comprises the step of providing all or at least a plurality of the blade plates with a plurality of micro grooves extending from the at least one hole in the blade plate to the outer edge of the blade plate. The system of micro grooves is preferably formed as a one-to-many manifold type of micro grooves wherein one primary micro groove extends from the at least one hole to a first distributing node and two or more secondary micro grooves extend from the first distributing node to the outer edge of the blade plates.

In a further embodiment of the invention, the method comprises the step of working the sintered rotor/stator blade mechanically to obtain the final outer shape of the rotor/stator blade. The minimum amount of working that must be done to the sintered rotor/stator blade is to remove any step-like surface of the rotor/stator blade such that a smooth outer surface is obtained. Any inaccuracies in the cut-out shapes of individual blade plates or in the stacking of the rotor/stator blades before or during the sintering process may also be corrected by machining the rotor/stator after the sintering process has taken place.

In a further embodiment of the invention, the method comprises the step of providing the rotor/stator blade with a top plate and a bottom element. The top and/or the bottom element comprises means for supplying cooling liquid to the at least one supply duct of the rotor/stator blade.

In a further embodiment of the invention, the method comprises the step of providing two or more holes in the blade plates and a separate system of distributing micro grooves for each hole, whereby the sintered rotor/stator blade is formed with two or more supply ducts. Obviously, not all blade plates need to be provided with a system of micro grooves for each hole, and any given hole in a blade plate may be provided with one micro duct system or a plurality of separate micro duct systems.

There is also provided a use of a sintering process for the manufacturing of a rotor blade or a stator blade for rotary machinery wherein a number of thin blade plates, stacked on top of each other, are sintered to form the rotor or the stator blade.

Other features and advantages of the invention will appear from the following description of a preferred embodiment of the invention, with reference to the figures where:

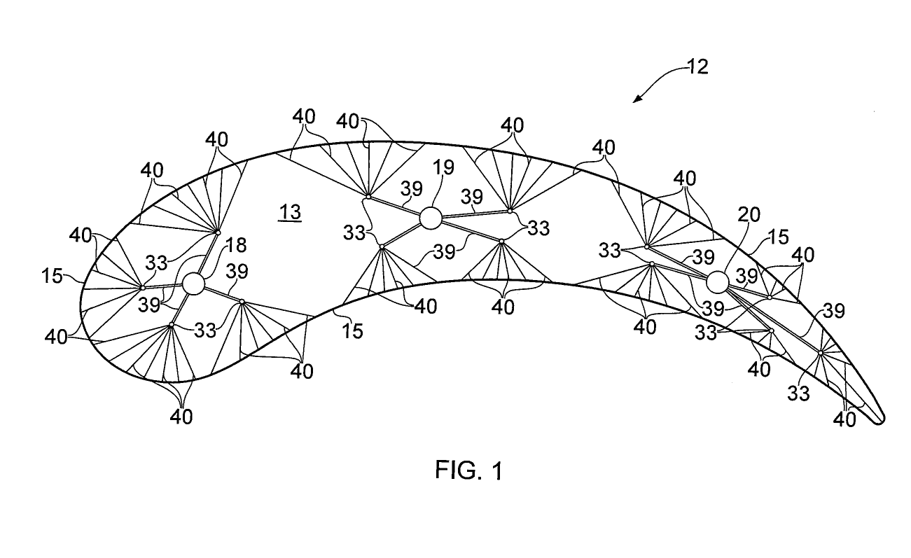

FIG. 1 discloses a simplified view of a rotor/stator blade according to the present invention.

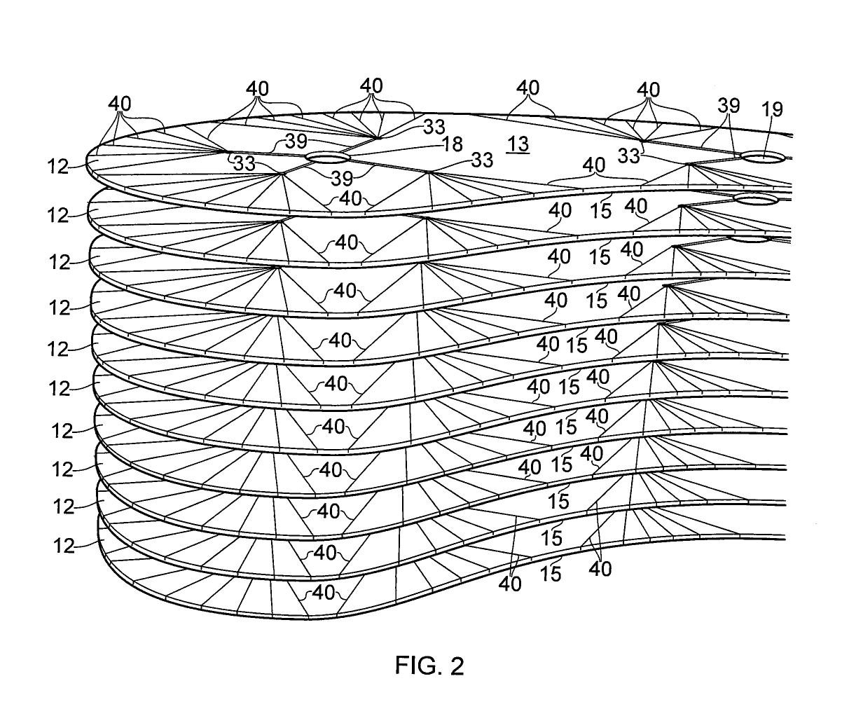

FIG. 2 shows an exploded view of a part of the rotor/stator blade where the micro duct system of the individual blade plates can be seen.

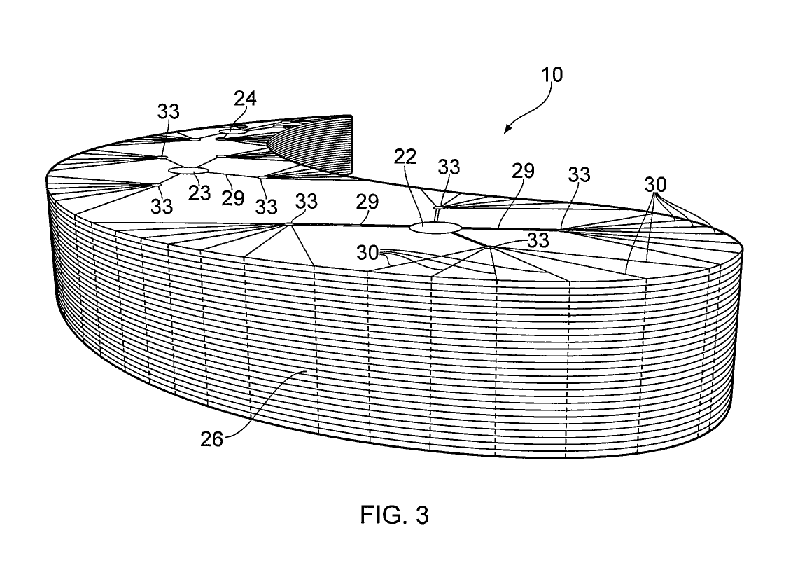

FIG. 3 is a view of a blade plate with a plurality of holes with their respective systems of micro ducts.

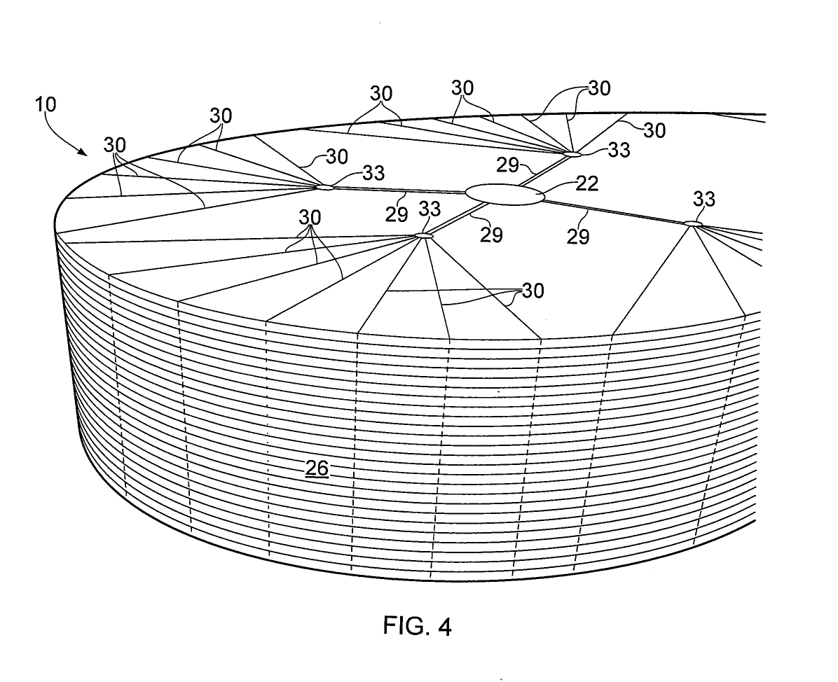

FIG. 4 is a view of a portion of the blade plate shown in FIG. 3.

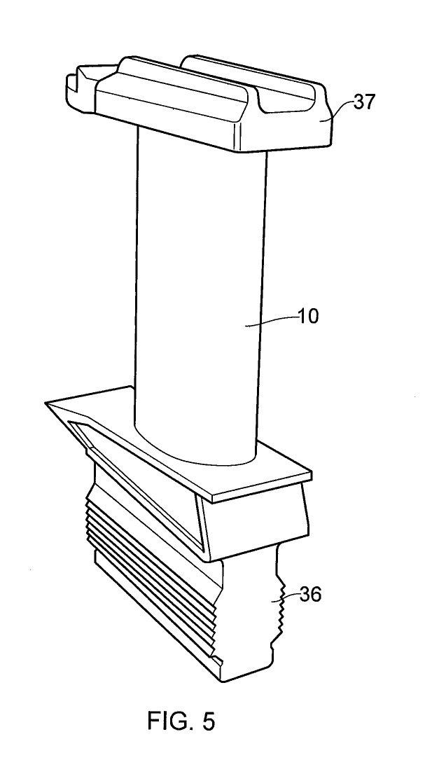

FIG. 5 shows a rotor/stator blade provided with a bottom element and a top plate.

In FIG. 1 there is shown a blade plate 12 with an upper side 13. The blade plate is provided with a first hole 18, a second hole 19 and a third hole 20 which will form supply ducts when a plurality of blade plates 12 are stacked on top of each other and sintered to form a solid rotor/stator blade. In this embodiment of the invention the blade plate 12 is provided with three holes 18, 19, 20, but the blade plate 12 may of course be provided with a different number of holes, i.e. one, two, four, five or more holes depending on the design and size of the blade plates 12 that eventually will form the rotor/stator blade 10 (FIGS. 3-5). From each of the holes 18, 19, 20 the blade plate 12 is provided with at least one, but preferably, as shown in the figures, a plurality of primary micro grooves 39, each of which extends to a first distributing node 33. In this embodiment of the invention shown in FIG. 1 there is provided four or five primary grooves 39 extending from each hole 18, 19, 20, but from each hole 18, 19, 20 there may of course be provided a different number of primary grooves, i.e. one, two, three, six, seven or more depending on the design and size of the blade plates 12. From each distributing node 33 there is provided a plurality of secondary micro grooves 40 which extend to the outer edge 15 of the blade plate 12. The number of secondary micro grooves will depend on the design and the size of the blade plate 12. The outer edge 15 extends around the entire perimeter of the blade plate 12. For the sake of clarity not all the secondary micro grooves 40 shown in the figure have been indicated with reference numbers. The whole system of primary micro grooves 39 and secondary micro grooves 40 are designed such that the different parts of the surface of a finished rotor/stator blade can be sufficiently cooled by evaporation of the cooling liquid during use of the rotor/stator blade.

In FIG. 2 there is shown an exploded view of a number of blade plates 12 stacked on top of each other. It should be noted that only a front part of the blade plates 12 are shown in FIG. 2. As explained in connection with FIG. 1 above, each blade plate 12 is provided with holes 18, 19, 20, primary micro grooves 39 extending to respective first distributing nodes 33, and secondary micro grooves extending from the first distributing nodes 33 to the outer edge 15 of the blade plates 12. Again, for the sake of clarity, not all the distributing nodes 33 and micro grooves 40 shown in the figure have been indicated with reference numbers.

In FIG. 3 there is shown a stack of blade plates 12 which forms a rotor/stator blade 10 while FIG. 4 shows a front portion of the rotor/stator blade 12. When the blade plates 12 are stacked on top of each other, as shown in FIGS. 3 and 4, the first hole 18, the second hole 19 and the third hole 20 provided in the blade plates 12 will form a first supply duct 22, a second supply duct 23 and a third supply duct 24 respectively in the rotor/stator blade 10, while the primary micro grooves 39 and the secondary micro grooves 40 in the blade plates 12 will form primary micro ducts 29 and secondary micro ducts 30 respectively in the rotor/stator blade 10. A primary duct 29, therefore, extends from the supply ducts 22, 23, 24 to a first distributing node 33 and a plurality of secondary micro ducts 30 extend from the first distributing node 33 to the outer surface 26 of the rotor/stator blade 10. The nodes 33 may simply be formed by the end of each primary duct 29, or may alternatively be formed as an enlarged volume at the end of the primary ducts 29, as indicated in FIG. 4, forming a small reservoir for cooling liquid. Each of the supply ducts 22, 23, 24 are provided with the necessary number of such manifolded micro duct systems to provide sufficient cooling liquid to the outer surface 26 of the rotor/stator blade 10 such that there is sufficient evaporation of cooling liquid to keep the temperature of the outer surface 26 of the rotor/stator blade 10 below the temperature that the rotor/stator blade material can withstand.

In FIG. 5 a rotor/stator blade 10 is shown with a top plate 37 and secured to a bottom element 36. The top plate 37 may, as already explained, be provided as a part of a sealing arrangement for the rotary machine. Obviously, it is not necessary to provide the rotor/stator blade with a top plate 37 as shown in FIG. 5. The bottom element 36 is mounted to the rotary machinery and the cooling liquid is preferably supplied to the supply ducts 22, 23, 24 through one or more ducts in the bottom element 36.

1. Rotor or stator blade for rotary machinery, the rotor/stator blade comprising a number of thin blade plates wherein at least a plurality of the rotor/stator blades are provided with at least one hole forming at least one supply duct when the blade plates are stacked on top of each other to form the rotor/stator blade, wherein the blade plates are joined together by means of sintering such that a solid rotor/stator blade with an outer surface is formed, and that the rotor/stator blade comprises a system of distributing micro ducts extending from the at least one supply duct to the outer surface of the rotor/stator blade, fanning out in such a way that the number of micro ducts extending out to the outer surface of the rotor/stator blade is equal to or greater than the number of micro ducts extending from the at least one supply duct, thereby providing cooling liquid to the outer surface of the rotor/stator blade such that the cooling liquid cools the rotor/stator blade by evaporation when the rotor/stator blade is in use.

2. Rotor or stator blade according to claim 1,
wherein the system of distributing micro ducts is formed by a plurality of single micro ducts extending from the at least one supply duct to the outer surface of the rotor/stator blade.

3. Rotor or stator blade according to claim 1,
wherein the system of micro ducts is formed by a one-to-many manifold type of micro ducts wherein at least one primary micro duct extends from the at least one supply duct to a first distributing node and two or more secondary micro ducts extend from the first distributing node to the outer surface of the rotor/stator blade.

4. Rotor or stator blade according to claim 3,
wherein at least one of the secondary micro ducts extends to a second distributing node from which two or more tertiary micro ducts extend to the outer surface of the rotor/stator blade, while the other secondary micro ducts, if there is any, extend directly to the outer surface of the rotor/stator blade.

5. Rotor or stator blade according to claim 1,
wherein the rotor/stator blade is provided with two or more supply ducts for cooling liquid, wherein each supply duct is provided with a separate system of micro ducts extending from the supply duct and spreading out towards the outer surface of the rotor/stator blade.

6. Rotor or stator blade according claim 1,
wherein the rotor/stator blade is provided with a bottom element and optionally a top plate, at least one of which comprises means for supplying cooling liquid to the at least one supply duct of the rotor/stator blade.

7. Rotor or stator blade according to claim 1,
wherein a plurality or all of the blade plates, having an upper side, an underside and an outer edge, are provided with at least one hole and a system of distributing micro grooves in the surface of the upper side or underside of the blade plates, the micro grooves extending from the at least one hole to the edge of the blade plates.

8. Rotor or stator blade according to claim 1,
wherein the blade plates are provided with a thickness which is less than 1 mm.

9. Rotor or stator blade according to claim 1,
wherein micro grooves, which are formed in the blade plates, have a depth which is less than or equal to half the thickness of the blade plates.

10. Method for the manufacturing of a rotor blade or a stator blade for rotary machinery wherein the following steps are carried out:
providing a number of thin blade plates with an upper side, an underside and an outer edge,
providing all or at least a plurality of the blade plates with a least one hole such that when the blade plates are stacked on top of each other, into an assembly of blade plates, at least one supply duct for cooling liquid is formed by the holes,
wherein the method further comprises the steps of:
providing all or at least a plurality of the blade plates with a system of micro grooves in the surface of the upper side or the underside of the blade plates, the system of micro grooves fanning out from the at least one hole to the outer edge of the blade plates in such a way that the number of micro grooves extending to the outer edge of the blade plate is equal to or greater than the number of micro grooves extending from the at least one hole,
sintering the assembly of blade plates to form a solid rotor/stator blade with an outer surface, the sintered rotor/stator blade comprising the at least one supply duct and a system of micro ducts distributing the cooling liquid to the outer surface of the rotor/stator blade such that the cooling liquid cools the rotor/stator blade by evaporation when the rotor/stator blade is in use.

11. Method according to claim 10,
wherein the method further comprises the step of providing all or at least a plurality of the blade plates with a plurality of micro grooves extending from the at least one hole in the blade plate to the outer edge of the blade plate.

12. Method according to claim 10,
wherein the method further comprises the step of forming the system of micro grooves as a one-to-many manifold type of micro grooves wherein one primary micro groove extends from the at least one hole to a first distributing node and two or more secondary micro grooves extend from the first distributing node to the outer edge of the blade plates.

13. Method according to claim 10,
wherein the method further comprises the step of working the sintered blade mechanically to obtain the final outer shape of the rotor/stator blade.

14. Method according to claim 10,
wherein the method further comprises the step of producing the micro grooves and nodes in the surface of the upper side or the underside of the blade plates by using photo etching.

15. Method according to claim 10,
wherein the method further comprises the step of providing the rotor/stator blade with a top plate and a bottom element, at least one of which comprises means for supplying cooling liquid to the at least one supply duct of the rotor/stator blade.

16. Method according to claim 10,
wherein the method further comprises the step of providing two or more holes in the blade plates and a separate system of distributing micro grooves for each hole, whereby the sintered rotor/stator blade is formed with two or more supply ducts.
